(19) United States
(12) Patent Application Publication
(10) Pub. No.: US 2026/0323645 A1
(43) Pub. Date: Oct. 15, 2026

(54) JOINT CODEBOOK AND NON-CODEBOOK BASED PHYSICAL UPLINK SHARED CHANNEL TRANSMISSION

(71) Applicant: Nokia Technologies Oy, Espoo (FI)

(72) Inventors: Juha Pekka KARJALAINEN, Oulu (FI); Sami-Jukka HAKOLA, Oulu (FI); Timo KOSKELA, Oulu (FI); Keeth Saliya Jayasinghe LADDU, Espoo (FI)

(21) Appl. No.: 19/114,639

(22) PCT Filed: Sep. 7, 2023
(86) PCT No.: PCT/IB2023/058887

§ 371 Date: Mar. 24, 2025

Related U.S. Application Data
(60) Provisional application No. 63/411,911, filed on Sep. 30, 2022.

(51) Int. Cl. H04W 72/21; H04B 7/06

(52) U.S. Cl. CPC H04W 72/21; H04B 7/0639

(57) ABSTRACT

Systems, methods, apparatuses, and computer program products for enhancing SDM based simultaneous multi-panel PUSCH transmissions. One method may include receiving, from a network device, uplink resource configuration information indicating that different uplink transmit precoding types are enabled for simultaneous transmissions of a plurality of uplink data channels from the apparatus; and transmitting, to the network device, at least two of the plurality of uplink data channels simultaneously using the different uplink transmit precoding types.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for spatial division multiplexing (SDM) based simultaneous multi-panel physical uplink shared channel (PUSCH) transmissions.

### BACKGROUND:

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, by a user equipment, from a network device, uplink resource configuration information indicating that different uplink transmit precoding types are enabled for simultaneous transmissions of a plurality of uplink data channels from the user equipment. The method may further include transmitting, to the network device, at least two of the plurality of uplink data channels simultaneously using the different uplink transmit precoding types.

In accordance with certain example embodiments, an apparatus may include means for receiving, from a network device, uplink resource configuration information indicating that different uplink transmit precoding types are enabled for simultaneous transmissions of a plurality of uplink data channels from the apparatus. The apparatus may further include means for transmitting, to the network device, at least two of the plurality of uplink data channels simultaneously using the different uplink transmit precoding types.

In accordance with various example embodiments, a non-transitory computer readable medium may include program instructions that, when executed by an apparatus, cause the apparatus to perform at least a method. The method may include receiving, from a network device, uplink resource configuration information indicating that different uplink transmit precoding types are enabled for simultaneous transmissions of a plurality of uplink data channels from an apparatus. The method may further include transmitting, to the network device, at least two of the plurality of uplink data channels simultaneously using the different uplink transmit precoding types.

In accordance with some example embodiments, a computer program product may perform a method. The method may include receiving, from a network device, uplink resource configuration information indicating that different uplink transmit precoding types are enabled for simultaneous transmissions of a plurality of uplink data channels from an apparatus. The method may further include transmitting, to the network device, at least two of the plurality of uplink data channels simultaneously using the different uplink transmit precoding types.

In accordance with certain example embodiments, an apparatus may include at least one processor and at least one memory storing instructions that, when executed by the at least one processor, cause the apparatus at least to receive, from a network device, uplink resource configuration information indicating that different uplink transmit precoding types are enabled for simultaneous transmissions of a plurality of uplink data channels from the apparatus. The at least one memory and instructions, when executed by the at least one processor, may further cause the apparatus at least to transmit, to the network device, at least two of the plurality of uplink data channels simultaneously using the different uplink transmit precoding types.

In accordance with various example embodiments, an apparatus may include receiving circuitry configured to receive, from a network device, uplink resource configuration information indicating that different uplink transmit precoding types are enabled for simultaneous transmissions of a plurality of uplink data channels from the apparatus. The apparatus may further include transmitting circuitry configured to transmit, to the network device, at least two of the plurality of uplink data channels simultaneously using the different uplink transmit precoding types.

In accordance with some example embodiments, a method may include transmitting, to a user equipment, uplink resource configuration information indicating that different uplink transmit precoding types are enabled for simultaneous transmissions of a plurality of uplink data channels from the user equipment. The method may further include receiving, from the user equipment, at least two of the plurality of uplink data channels simultaneously using the different uplink transmit precoding types.

In accordance with certain example embodiments, an apparatus may include means for transmitting, to a user equipment, uplink resource configuration information indicating that different uplink transmit precoding types are enabled for simultaneous transmissions of a plurality of uplink data channels from the user equipment. The apparatus may further include means for receiving, from the user equipment, at least two of the plurality of uplink data channels simultaneously using the different uplink transmit precoding types.

In accordance with various example embodiments, a non-transitory computer readable medium may include program instructions that, when executed by an apparatus, cause the apparatus to perform at least a method. The method may include transmitting, to a user equipment, uplink resource configuration information indicating that different uplink transmit precoding types are enabled for simultaneous transmissions of a plurality of uplink data channels from the user equipment. The method may further include receiving, from the user equipment, at least two of the plurality of uplink data channels simultaneously using the different uplink transmit precoding types.

In accordance with some example embodiments, a computer program product may perform a method. The method may include transmitting, to a user equipment, uplink resource configuration information indicating that different uplink transmit precoding types are enabled for simultaneous transmissions of a plurality of uplink data channels from the user equipment. The method may further include receiving, from the user equipment, at least two of the plurality of uplink data channels simultaneously using the different uplink transmit precoding types.

In accordance with certain example embodiments, an apparatus may include at least one processor and at least one memory storing instructions that, when executed by the at least one processor, cause the apparatus at least to transmit, to a user equipment, uplink resource configuration information indicating that different uplink transmit precoding types are enabled for simultaneous transmissions of a plurality of uplink data channels from the user equipment. The at least one memory and instructions, when executed by the at least one processor, may further cause the apparatus at least to receive, from the user equipment, at least two of the plurality of uplink data channels simultaneously using the different uplink transmit precoding types.

In accordance with various example embodiments, an apparatus may include transmitting circuitry configured to transmit, to a user equipment, uplink resource configuration information indicating that different uplink transmit precoding types are enabled for simultaneous transmissions of a plurality of uplink data channels from the user equipment. The apparatus may further include receiving circuitry configured to receive, from the user equipment, at least two of the plurality of uplink data channels simultaneously using the different uplink transmit precoding types.

### BRIEF DESCRIPTION OF THE DRAWINGS

For a proper understanding of example embodiments, reference should be made to the accompanying drawings, wherein:

FIG. 1 illustrates an example of single downlink control information indicator for time-division multiplexing multi-transmission reception point PUSCH repetition and antenna arrangement selection.

FIG. 2 illustrates an example of single codeword for the SDM with single downlink control information indicator.

FIG. 3 illustrates an example of a signaling diagram according to certain example embodiments.

FIG. 4 illustrates an example of a flow diagram of a method according to some example embodiments.

FIG. 5 illustrates an example of a flow diagram of another method according to various example embodiments.

FIG. 6 illustrates an example of various network devices according to certain example embodiments.

FIG. 7 illustrates an example of a 5G network and system architecture according to some example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for enhancing SDM based simultaneous multi-panel PUSCH transmissions is not intended to limit the scope of certain example embodiments, but is instead representative of selected example embodiments.

Some example embodiments discussed herein may relate to 3GPP NR physical layer design for multiple input multiple output (MIMO) enhancements in Rel-18 and beyond. In particular, various example embodiments may enable joint usage of different precoding types (i.e., codebook and non-codebook) for simultaneous multi-panel PUSCH transmission with different single downlink control information (S-DCI) indication options with one or more transmission reception points (TRPs).

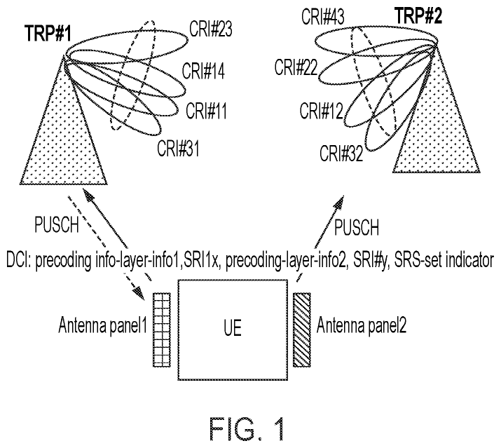

FIG. 1 depicts an example of 3GPP Rel-17 S-DCI for time-division multiplexing (TDM) based multi-TRP (M-TRP) PUSCH with and without repetition and antenna arrangement selection between two TRPs. 3GPP Rel-17 aims to enhance the reliability of uplink (UL) transmission in the context of multi-TRP scenario. Based on the Rel-17 capability set index reporting, a network may be aware of the UE antenna arrangement (including information on the number of UL SRS antenna ports) specific transmission capabilities of UL SRS codebook-based transmissions into a certain spatial UL direction associated with reported DL reference signal/signal (i.e., non-zero power (NZP)-channel state information (CSI)-reference signal (RS) or synchronization signal block (SSB)). Based on this information, the network may trigger transmissions of two different UL sounding reference signal (SRS) resource sets by using a codebook to obtain TRP-specific transmitted precoding matrix indicator (TPMI) hypotheses (i.e., determining precoder indexes and rank selections) antenna arrangement, specifically for PUSCH transmissions. Two different UL SRS resource sets may have been configured with two different/joint downlink (DL) and UL/UL transmission configuration indicator (TCI) states associated as the spatial source. Additionally, these two different UL SRS resource sets can also be configured with follow UnifiedTCIStateSRS-R17 information enabling dynamic spatial information update based on indicated TCI states. Based on obtained TRP-specific TPMI and sounding reference signal resource indicator (SRI) information, the network may trigger non-simultaneous TRP-specific Rel-17 PUSCH transmissions by indicating via DCI any of single SRS resource set indicator (i.e., 2-bits reserved (e.g., 4 different values)) when two SRS resource sets are configured with usage codebook/non-codebook, and 0-bits otherwise. The first value out of the four possible values of DCI codepoint may be used to indicate which of the two SRIs (i.e., the first or the second) may be used to enable dynamic switching between single TRP (i.e., either TPR1 or TRP2) PUSCH transmission in time division multiplexing (TDM) manner, and the other remaining two bits may be used to enable multi-TRP PUSCH transmissions between TRP1 and TRP2 in TDM manner with repetition. Either cyclical or sequential mapping may be configured via RRC for mapping two SRI to PUSCH repetitions. Moreover, for codebook based transmission, the DCI may include two separate codepoint fields for SRIs, and two precoding information and number of layers fields. The first field may indicate the number of layers, whereas the second field may not. For non-codebook based transmission, the DCI may consist of two SRI codepoint fields, wherein the first one may indicate the layers, and second may not. For both codebook and non-codebook. Additionally, the DCI may also include antenna port information that defines indicated demodulation reference signal (DMRS) antenna port combinations. Furthermore, in Rel-17, the UE may assume both first and second precoding information (i.e., codebook) or SRI (i.e., non-codebook) to be associated with the same number of layers (i.e., equal transmission rank).

3GPP Rel-17 may enable the UE to be configured using codebook or non-codebook-based PUSCH transmissions. Based on this configuration, the UE may assume that, upon receiving DCI with or without UL grants, SRS indicators, and precoding information may be associated with either codebook or non-codebook based PUSCH transmissions.

In 3GPP Rel-18 , it may be important to identify and specify necessary enhancements for UL MIMO, although necessary enhancements on DL MIMO that facilitate the use of large antenna array (not only for frequency range (FR)1 but also for FR2) would still need to be introduced to fulfill the request for evolution of NR deployments.

Higher peak data rate for UL may play a significant role in short-range applications, such as home entertainment, video surveillance/monitoring in industrial/healthcare/safety, IAB, and other applications where power, form-factor, and cost of devices are not as stringent as traditional handheld devices. UL transmissions with >4Tx may be useful to bridge the gap between DL and UL spectral efficiency, in both FR1 and FR2. Thus, it may be beneficial to develop methods and/or signaling solutions to overcome this problem for 3GPP Rel-18 and beyond.

One of the objectives of 3GPP Rel-18 NR MIMO Evo DL UL includes defining how to provide specification support for simultaneous multi-panel UL transmission with 2 panels (STx2P). For example, in order to facilitate simultaneous multi-panel UL transmission for higher UL throughput/reliability, focusing on FR2 and multi-TRP, assuming up to 2 TRPs and up to 2 panels, and targeting customer premises equipment/fixed wireless access/vehicle/industrial devices, UL precoding indications for PUSCH may be considered, where no new codebook is introduced for multi-panel simultaneous transmission. The total number of layers may be up to four across all panels, and the total number of codewords may be up to two across all panels, considering single DCI and multi-DCI based multi-TRP operation. In addition, UL beam indications for physical uplink control channel (PUCCH)/PUSCH may be considered, where unified TCI framework extension in objective 2 may be assumed, considering single DCI and multi-DCI based multi-TRP operation. For the case of multi-DCI based multi-TRP operation, only PUSCH+PUSCH, or PUCCH+PUCCH may be transmitted across two panels in a same component carrier (CC).

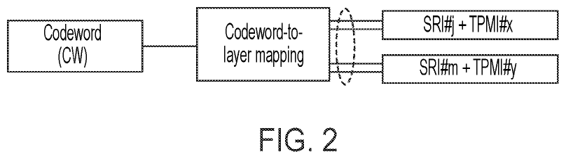

FIG. 2 illustrates an example of different layer combinations (i.e., {1+1, 1+2, 2+1, 2+2}) with single codeword for the SDM scheme with single-DCI support.

As discussed above, 3GPP Rel-17 only provides support for antenna arrangement specific PUSCH transmissions, either with codebook or non-codebook-based precoding. Since Rel-18 UEs may be equipped with multiple antenna arrangements associated with different phase coherency capabilities (i.e., full-coherency, partial-coherency, non-coherency) as well as channel conditions (e.g., propagation loss, line of sight (LoS)/no LoS (NLoS) that may vary between the UE and different TPRs, it would be beneficial to enable M-DCI and S-DCI operations with simultaneous multi-panel PUSCH transmissions with different precoding types. As a result of this, PUSCH throughput associated with simultaneous multi-panel transmissions can be enhanced with respect to legacy operation. Moreover, enabling support for simultaneous usage of different precoding types associated with different antenna arrangements may enable enhanced configuration flexibility to use different precoding types according to the UE capabilities in different radio channel conditions and deployment scenarios. Furthermore, current 3GPP Rel-17 specifications only support use of single precoding type (i.e., TXConfig=codebook/nonCodebook) for all PUSCH transmissions in a cell, which may be semi-statistically configured for the UE. Therefore, more dynamic precoding (i.e., codebook, non-codebook) according to TRP specific channel conditions for each PUSCH transmission performance enhancement can be achieved in M-TRP operations.

Certain example embodiments described herein may have various benefits and/or advantages to overcome the disadvantages described above. For example, certain example embodiments may enable enhanced flexibility for a network to configure precoding types according to channel conditions and antenna arrangement specific coherency capabilities leading to enhanced simultaneous multipanel PUSCH performance (i.e., higher throughput with respect to legacy single type operations). This may be applicable for both S-DCI and M-DCI based simultaneous multi-panel PUSCH transmission in M-TRP scenarios. Thus, certain example embodiments discussed below are directed to improvements in computer-related technology.

Some example embodiments discussed herein relate to dynamic indication methods for joint usage of different UL TX precoding types (i.e., codebook and non-codebook) for simultaneous multi-panel PUSCH transmission with different DCI indication options with one or more TRPs. Furthermore, various embodiments propose a UE transmission procedure for joint usage of different UL transmitter (TX) precoding types (i.e., codebook and non-codebook) for simultaneous multi-panel PUSCH transmissions.

In certain example embodiments, a UE may indicate, via capability signaling (e.g., radio resource control (RRC)) for the network that it supports the joint usage of different precoding types for simultaneous multi-panel PUSCH transmission.

In some example embodiments, the UE may be configured with PUSCH-Config that enables the UE to perform UL simultaneous multi-panel transmission jointly with different UL TX precoding types (i.e., codebook and non-codebook). Moreover, layer ordering between different precoding types associated with PUSCH-Config may be defined. In order to enable joint usage of codebook and non-codebook for PUSCH, the UE may be configured with PUSCH-Config where TXConfig=codebook+nonCodeBook. Various example embodiments may also include higher layer configured parameter layer ordering for joint usage of codebook-nonCodebook for PUSCH-Config that defines layer ordering between codebook and non-codebook based precoding. As an example, when layer ordering is set to 1, layers associated with SRS resource set with usage=codebook may be ordered before layers associated with SRS resource set with usage=non-Codebook In another example, when layer ordering is set as 0 or void, layers associated with SRS resource set with usage=nonCodebook may be ordered before layers associated with SRS resource set with usage=Codebook. Any combination layer ordering having value of 0 or 1 associated with codebook or nonCodebook may be considered with this example.

In certain example embodiments, the network may implicitly indicate via S-DCI that the UE shall transmit simultaneously PUSCH via different SRS resources associated with different precoder types (i.e., codebook and non-codebook) with multiple antenna arrangements. The indication may reuse existing DCI codepoints. For example, implicit indications may be used for joint usage of different UL precoding types: when PUSCH-Config is configured with TXConfig=codebook+nonCodebook, each UL SRS resource set usage associated with indicated corresponding SRI may indicate the indicated precoding type for associated layers. In another example, an SRS resource set indicator may indicate the use of SDM based simultaneous multi-panel PUSCH transmission. In yet another example, an SRI may be associated with UL SRS set configured with codebook or non-codebook based PUSCH (i.e., not fixed/floating). When SRI is associated with UL SRS set usage nonCodebook, it may be an index that indicates the number of layers and layer combinations subject of number of configured resources. When SRI is associated with UL SRS set usage Codebook, it may be an index to indicate one or more UL SRS resources subject to a number of configured resources and ul-fullPowerTransmission mode. In various example embodiments, “not fixed”/“floating” may refer to precoding types that are not fixed, and it may depend on UL SRS set usage configurations associated with SRS resource indicator. Additionally or alternatively, there may be additional indicators for precoding information and number of layers (i.e., not fixed/floating). For example, when precoding type is nonCodebook and indicated by usage of corresponding UL SRS resource set, the value associated with precoding and number of layers may be void or zero; otherwise, it may provide an index to TPMI and layer combinations associated with corresponding indicated SRI; a second SRS resource indicator (SRI) associated UL SRS resource set configured with codebook or non-codebook based PUSCH (i.e., not fixed/floating). When second SRI is associated with UL SRS set usage nonCodebook, it may be an index to indicate the number of layers and layer combinations subject of number of configure resources. When second SRI is associated with UL SRS set usage Codebook, it may be an index to indicate one or more UL SRS resources subject to number of configured resources and ul-fullPowerTransmission mode. Some example embodiments may also use second precoding information and a number of layers PUSCH (i.e., not fixed/floating): when precoding type is nonCodebook indicated by usage of corresponding UL SRS resource set, the value of second precoding information and a number of layers may be void or zero; otherwise, it may provide an index to TPMI and layer combinations associated with corresponding SRI; and/or a DMRS antenna port information indicator. Alternatively, an additional DMRS antenna port information indicator as a codepoint field may also be included as part of DCI.

Various example embodiments may include an alternative implicit indication, which may include any of an SRS resource set indicator configured to indicate SDM based simultaneous multi-panel PUSCH transmissions; there may also be an SRS resource indicator associated with codebook based PUSCH (i.e., fixed/predefined). “Fixed”/“preconfigured” means that the precoding type is fixed/predetermined for an associated SRS resource indicator. When SRI is associated with UL SRS resource set usage Codebook, it may be an index to indicate one or more UL SRS resources subject to a number of configured resources and ul-fullPowerTransmission mode; precoding information and a number of layers (i.e., fixed/predefined) that may provide an index to TPMI and layer combinations associated with corresponding SRI; a second resource indicator associated with non-codebook based PUSCH (i.e., fixed/predefined), wherein when precoding type is non-codebook is an index to indicate the number of layers and layer combinations subject of number of configure resources; second precoding information and a number of layers PUSCH (i.e., fixed/predefined), wherein when precoding type is nonCodebook, the value of the second precoding information and a number of layers is void or zero: void; and/or a DMRS antenna port information indicator. Alternatively, an additional DMRS antenna port information indicator as codepoint field may also include as part of DCI.

In certain example embodiments, a first SRI may indicate (fixed/predetermined: nonCodebook); a second SRI may indicate (not fixed/float). When second SRI is associated with UL SRS set usage nonCodebook, it may be an index that indicates the number of layers and layer combinations subject of number of configure resources. When second SRI is associated with UL SRS set usage Codebook, it may be an index to indicate one or more UL SRS resources subject to a number of configured resources and ul-fullPowerTransmission mode; a first precoding information and a number of layers may indicate (fixed/predetermined: void); and a second precoding information and a number of layers may indicate (not fixed/float) when precoding type is nonCodebook indicated by usage of corresponding UL SRS resource set, the value of second precoding information and a number of layers may be void or zero; otherwise, it may provide an index to TPMI and layer combinations associated with corresponding SRI; and/or a DMRS antenna port information indicator. Alternatively, an additional DMRS antenna port information indicator as codepoint field may also include as part of DCI.

In some example embodiments, a first SRI may indicate (not fixed/float) When first SRI is associated with UL SRS set usage nonCodebook, it may be an index that indicates the number of layers and layer combinations subject of number of configure resources. When first SRI is associated with UL SRS set usage Codebook, it may be an index to indicate one or more UL SRS resources subject to a number of configured resources and ul-fullPowerTransmission mode; a second SRI may indicate (fixed/predetermined: nonCodebook) a second SRI associated with non-codebook based PUSCH wherein when precoding type is non-codebook is an index to indicate the number of layers and layer combinations subject of number of configure resources; a first precoding information and a number of layers may indicate (float) when precoding type is nonCodebook indicated by usage of corresponding UL SRS resource set, the value of first precoding information and a number of layers may be void or zero; otherwise, it may provide an index to TPMI and layer combinations associated with corresponding SRI; and a second precoding information and a number of layers may be indicate void or zero; and/or a DMRS antenna port information indicator. Alternatively, an additional DMRS antenna port information indicator as codepoint field may also include as part of DCI.

In various example embodiments, a first SRI may indicate (float); When first SRI is associated with UL SRS set usage nonCodebook, it may be an index that indicates the number of layers and layer combinations subject of number of configure resources. When first SRI is associated with UL SRS set usage Codebook, it may be an index to indicate one or more UL SRS resources subject to a number of configured resources and ul-fullPowerTransmission mode. a second SRI may indicate (fixed: Codebook) when second SRI is associated with UL SRS set usage Codebook, it may be an index to indicate one or more UL SRS resources subject to a number of configured resources and ul-fullPowerTransmission mode; a first precoding information and a number of layers may indicate (float) when precoding type is nonCodebook indicated by usage of corresponding UL SRS resource set, the value of first precoding information and a number of layers may be void or zero; otherwise, it may provide an index to TPMI and layer combinations associated with corresponding SRI; and a second precoding information and a number of layers may provide an index to TPMI and layer combinations associated with corresponding SRI.

In certain example embodiments, the first and second SRI may refer to the most recent UL SRS transmission of resource set usage (i.e., codebook and non-codebook).

In some example embodiments, upon reception of UL S-DCI with grant, when PUSCH-Config is configured with TXConfig=codebook+nonCodebook, the UE may implicitly assume that when two different UL SRS resource sets with difference usages (i.e., codebook and nonCodebook) are indicated, the UE should transmit different PUSCH layers (e.g., DMRS access points (APs)) associated with SRS resource with usage codebook indicated by SRI and SRS resources with usage nonCodebook indicated by SRIs. Furthermore, the UE may implicitly assume that, depending on the configured layer ordering for joint usage of codebook-nonCodebook, when layer ordering is set to 1, layers associated with SRS resource set with usage=codebook may be ordered firstly before layers associated with SRS resource set with usage=non-Codebook. In addition, when layer ordering for joint usage of codebook-nonCodebook indication is set to zero, the order of layer association may be reversed.

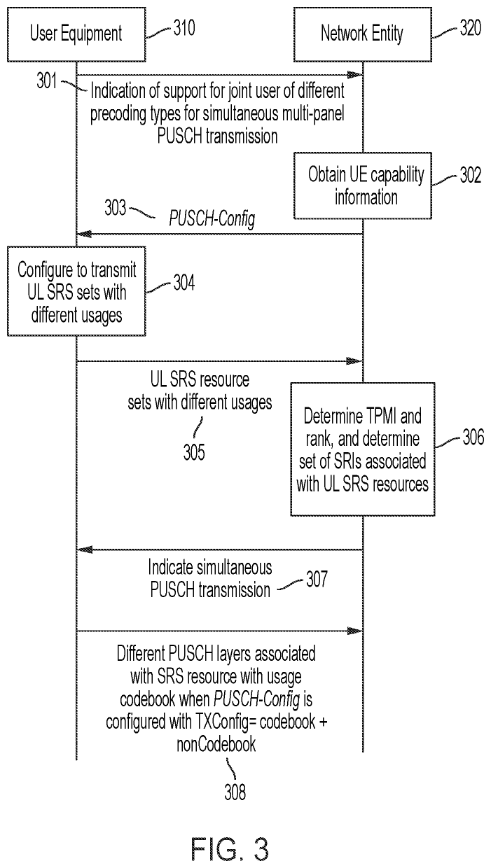

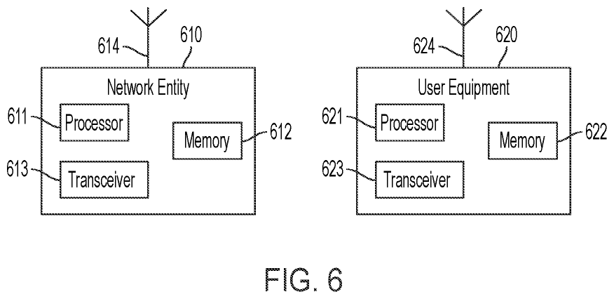

FIG. 3 illustrates an example of a signaling diagram for S-DCI based indications for joint usage of different precoding types for simultaneous multi-panel PUSCH. NE 320 and UE 310 may be similar to NE 610 and UE 620, as illustrated in FIG. 6, according to certain example embodiments. Specifically, FIG. 3 illustrates an example for enabling simultaneous multi-panel PUSCH transmissions with multiple precoding types, wherein UE 310 is equipped with four TX antenna arrangements, where one pair of antenna arrangements is associated with simultaneous multi-panel PUSCH transmissions with TRP1 and TPR2.

At 301, UE 310 may indicate, via RRC-based capability reporting for NE 320, that UE 310 supports joint usage of different precoding types for simultaneous multi-panel PUSCH transmissions.

At 302, based on the capability signaling reporting by UE 310, NE 320 may obtain information about UL SRS transmission capabilities (e.g., number of antenna ports) of UE 310 for each reported DL resource (e.g., NZP-CSI-RS or SSB (i.e., DL TX beam direction)).

At 303, UE 310 may be configured with PUSCH-Config, where simultaneous multipanel PUSCH transmissions may be enabled with different precoding types (i.e., TXConfig=codebook+nonCodeBook).

At 304, based on the capability reporting for supporting joint precoding types, and capability signaling reporting of UE 310, UE 310 may be configured to transmit with at least two UL SRS resources sets with different usages (e.g., set #1 with codebook, and set #2 without codebook (i.e., nonCodeBook)). For example, set #1 with codebook may be with two SRS resources (i.e., SRI #1 with 2 APs, and SRI #2 with 4 APs), while set #2 may be configured with usage non-codebook with 4 single AP resources (i.e., SRI #3, SRI #4, SRI #5, SRI #6). Each UL SRS resource set may be configured with followUnifiedTCIStateSRS-r17. In addition, some or all resources in resource set #1 may be configured with spatialRelationInfo associated with NZP-CSI-RS resources associated with TRP #1, and some or all resources in resource set #2 may be configured with spatialRelationInfo associated with NZP-CSI-RS resources associated with TRP #2. Moreover, UL SRS resource set #2 (e.g., periodic/semi-persistent/aperiodic) may be associated with DL NZP-CSI-RS resourceID for UL precoder determination at UE 310.

At 305, based on the configured two different UL SRS resource sets, UE 310 may transmit simultaneously or separately in time two different UL SRS resource sets with different usages (i.e., set #1: usage=codebook and set #2: usage=non-codebook) to two different TRPs (i.e., TRP1 and TRP2). For UL SRS resource sets with usage non-codebook, UE 310 may calculate the precoder used for transmission of SRS based on measurements of an associated NZP CSI-RS resource.

At 306, upon reception of two different UL SRS resource sets #1 and #2 (e.g., backhaul information exchange between TRP1 and TRP2 regarding to SRS resources), NE 320 may determine TPMI and rank (i.e., different hypothesis on TPMI associated with rank) associated with UL SRS resource set #1 (i.e., codebook), and may determine a set of SRIs (i.e., defining precoder and rank) associated with UL SRS resource set #2 (i.e., non-codebook). Thus, upon reception of the UL SRS resource set with usage codebook, NE 320 may need to perform different hypothesis which may include different TPMI+rank combinations (e.g., for 4 antenna port SRS), and NE 320 may need to perform 32 different hypothesis to cover TPMIs from 0-31 also covering layers (i.e., ranks) up to 4.

At 307, NE 320 may indicate, via S-DCI with UL grant (e.g., DCI 0_1) that UE 310 may or should transmit simultaneously PUSCH via different SRS resources associated with different precoder types (i.e., codebook and non-codebook) with multiple antenna arrangements by using various DCI fields. For example, the DCI fields may include a SRS resource set indicator, wherein >0 bits may define simultaneous multipanel PUSCH transmission; otherwise, second SRI and precoding and layer information may be void, and single antenna arrangement transmissions may be assumed.

In various example embodiments, the DCI fields may also include SRS resource indicators associated with a codebook or non-codebook based PUSCH indication table, depending on the associated resource set usage (i.e., codebook or non-codebook), rather than being based solely on a single value configured in PUSCH-Config. When an associated resource set is used with the usage codebook, the codepoint field may indicate an SRI associated with the number of UL SRS resource antenna ports subject to the number of configured resources within the set, as well as subject to ul-FullPowerTransmission mode. In another example, when the associated resource set is used with usage noneCodebook, the codepoint field may indicate SRIs subject to the number of UL SRS resource resources.

In some example embodiments, the DCI fields may also include precoding information and a number of layers; this may be void if the SRS resource indicators associated with UL SRS resource set with usage equals nonCodeBook, otherwise, the DCI fields may indicate TPMI index and a number of layers (i.e., rank) subject to ul-FullPowerTransmission mode.

The DCI fields may also include a second resource indicator associated with a codebook or non-codebook based PUSCH indication table depending on the associated resource set usage (i.e., codebook or non-codebook). For example, when an associated resource set is used with a usage codebook, the codepoint field may indicate SRI associated with the number of UL SRS resource antenna ports subject to number of configured resources within the set, as well as subject to ul-FullPowerTransmission mode. Alternatively, when an associated resource set is used with noneCodebook, the codepoint field may indicate SRIs subject to the number of UL SRS resource resources.

In some example embodiments, the DCI fields may include second precoding information and a number of layers; these fields may be void if SRS resource indicator is associated UL SRS resource set with usage=nonCodeBook; otherwise, the DCI fields may indicate TPMI index and a number of layers (i.e., rank), subject to ul-FullPowerTransmission mode. It is noted that layers associated with the first and second SRI, or first and second precoding information, may not depend on each other, and may be independently indicated.

The DCI fields may also include DMRS antenna port information; for example, the codepoint field may indicate a number of DMRS code division multiplexing (CDM) groups without data, as well as DMRS ports and number of frontloaded symbol. In general, first and second SRI may refer to the most recent UL SRS transmission of resource set usage (i.e., codebook and non-codebook).

At 308, upon receiving an UL S-DCI with grant, and when PUSCH-Config is configured with TXConfig=codebook+nonCodebook, UE 310 may implicitly assume that when two different UL SRS resource sets with difference usages (i.e., codebook and nonCodebook) are indicated, and UE 310 may transmit different PUSCH layers (e.g., DMRS APs) associated with SRS resources with usage codebook indicated by SRI and SRS resources with usage nonCodebook indicated by SRIs.

In some example embodiments, for SRI associated with codebook based transmission, UE 310 may determine its codebook subsets based on TPMIs, and upon receiving higher layer parameters codebookSubset in PUSCH-Config for PUSCH associated with DCI format 0_1.

Depending on configured layer ordering for joint usage of codebook-nonCodebook, when layer ordering is set to 1, layers associated with SRS resource set with usage=codebook may be ordered firstly before layers associated with SRS resource set with usage=non-Codebook. When layer ordering for joint usage of codebook-nonCodebook indication is set to zero, the order of layer association may be reversed.

In various example embodiments, depending on configured layer ordering, when layer ordering is set to 1, DMRS antenna ports associated with SRS resource set with usage=codebook may be ordered first before layers associated with SRS resource set with usage=non-Codebook. When layer ordering indication is set to zero, the order of layer association may be reversed.

In general, UE 310 may not be expected to update the SRS precoding information for SRS resources associated with nonCodebook if the gap from the last symbol of the reception of the aperiodic NZP-CSI-RS resource and the first symbol of the aperiodic SRS transmission may be less than a predetermined number of orthogonal frequency division multiplexing (OFDM) symbols.

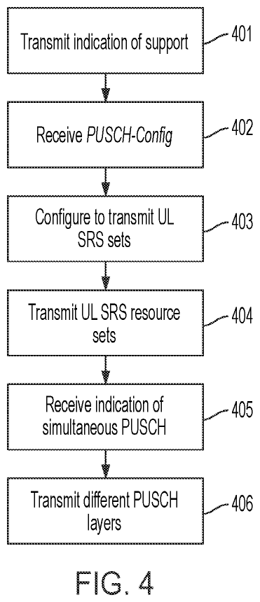

FIG. 4 illustrates an example of a flow diagram of a method for S-DCI based indications for joint usage of different precoding types for simultaneous multi-panel PUSCH that may be performed by a UE, such as UE 620 illustrated in FIG. 6, according to various example embodiments. Specifically, FIG. 4 illustrates an example for enabling simultaneous multi-panel PUSCH transmissions with multiple precoding types, wherein the UE may be equipped with four TX antenna arrangements, where one pair of antenna arrangements is associated with simultaneous multi-panel PUSCH transmissions with TRP1 and TPR2.

At 401, the method may include indicating, via RRC-based capability reporting for a NE, such as UE 620 illustrated in FIG. 6, that the UE supports joint usage of different precoding types for simultaneous multi-panel PUSCH transmissions.

At 402, the method may include the UE being configured with PUSCH-Config, where simultaneous multipanel PUSCH transmissions may be enabled with different precoding types (i.e., TXConfig=codebook+nonCodeBook).

At 403, based on the capability reporting for supporting joint precoding types, and capability signaling reporting of the UE, the method may include the UE being configured to transmit with at least two UL SRS resources sets with different usages (e.g., set #1 with codebook, and set #2 without codebook (i.e., nonCodeBook)). For example, set #1 with codebook may be with two SRS resources (i.e., SRI #1 with 2 APs, and SRI #2 with 4 APs), while set #2 may be configured with usage non-codebook with 4 single AP resources (i.e., SRI #3, SRI #4, SRI #5, SRI #6). Each UL SRS resource set may be configured with followUnifiedTCIStateSRS-r17. In addition, some or all resources in resource set #1 may be configured with spatialRelationInfo associated with NZP-CSI-RS resources associated with TRP #1, and some or all resources in resource set #2 may be configured with spatialRelationInfo associated with NZP-CSI-RS resources associated with TRP #2. Moreover, UL SRS resource set #2 (e.g., periodic/semi-persistent) may be associated with DL NZP-CSI-RS resourceID for UL precoder determination at the UE.

At 404, based on the configured two different UL SRS resource sets, the method may include transmitting simultaneously or separately in time two different UL SRS resource sets with different usages (i.e., set #1: usage=codebook and set #2: usage=non-codebook) to two different TRPs (i.e., TRP1 and TRP2). For UL SRS resource sets with usage non-codebook, the UE may calculate the precoder used for transmission of SRS based on measurements of an associated NZP CSI-RS resource.

At 405, the method may include receiving an indication via S-DCI with UL grant (e.g., DCI 0_1) that the UE may or should transmit simultaneously PUSCH via different SRS resources associated with different precoder types (i.e., codebook and non-codebook) with multiple antenna arrangements by using various DCI fields. For example, the DCI fields may include a SRS resource set indicator, wherein >0 bits may define simultaneous multipanel PUSCH transmission; otherwise, second SRI and PRI may be void, and single antenna arrangement transmissions may be assumed.

In various example embodiments, the DCI fields may also include SRS resource indicators associated with a codebook or non-codebook based PUSCH indication table, depending on the associated resource set usage (i.e., codebook or non-codebook), rather than being based solely on a single value configured in PUSCH-Config. When an associated resource set is used with the usage codebook, the codepoint field may indicate an SRI associated with the number of UL SRS resource antenna ports subject to the number of configured resources within the set, as well as subject to ul-FullPowerTransmission mode. In another example, when the associated resource set is used with usage noneCodebook, the codepoint field may indicate SRIs subject to the number of UL SRS resource resources.

In some example embodiments, the DCI fields may also include precoding information and a number of layers; this may be void if the SRS resource indicators associated with UL SRS resource set with usage equals nonCodeBook, otherwise, the DCI fields may indicate TPMI index and a number of layers (i.e., rank) subject to ul-FullPowerTransmission mode.

The DCI fields may also include a second resource indicator associated with a codebook or non-codebook based PUSCH indication table depending on the associated resource set usage (i.e., codebook or non-codebook). For example, when an associated resource set is used with a usage codebook, the codepoint field may indicate SRI associated with the number of UL SRS resource antenna ports subject to number of configured resources within the set, as well as subject to ul-FullPowerTransmission mode. Alternatively, when an associated resource set is used with noneCodebook, the codepoint field may indicate SRIs subject to the number of UL SRS resource resources.

In some example embodiments, the DCI fields may include second precoding information and a number of layers; these fields may be void if SRS resource indicator is associated UL SRS resource set with usage=nonCodeBook; otherwise, the DCI fields may indicate TPMI index and a number of layers (i.e., rank), subject to ul-FullPowerTransmission mode. It is noted that layers associated with the first and second SRI, or first and second precoding information, may not depend on each other, and may be independently indicated.

The DCI fields may also include DMRS antenna port information; for example, the codepoint field may indicate a number of DMRS CDM groups without data, as well as DMRS ports and number of frontloaded symbol. In general, first and second SRI may refer to the most recent UL SRS transmission of resource set usage (i.e., codebook and non-codebook).

At 406, upon receiving an UL S-DCI with grant, and when PUSCH-Config is configured with TXConfig=codebook+nonCodebook, the method may include implicitly assuming that when two different UL SRS resource sets with difference usages (i.e., codebook and nonCodebook) are indicated, and transmitting different PUSCH layers (e.g., DMRS APs) associated with SRS resources with usage codebook indicated by SRI and SRS resources with usage nonCodebook indicated by SRIs.

In some example embodiments, for SRI associated with codebook based transmission, the UE may determine its codebook subsets based on TPMIs, and upon receiving higher layer parameters codebookSubset in PUSCH-Config for PUSCH associated with DCI format 0_1.

Depending on configured layer ordering for joint usage of codebook-nonCodebook, when layer ordering is set to 1, layers associated with SRS resource set with usage=codebook may be ordered firstly before layers associated with SRS resource set with usage=non-Codebook. When layer ordering for joint usage of codebook-nonCodebook indication is set to zero, the order of layer association may be reversed.

In various example embodiments, depending on configured layer ordering, when layer ordering is set to 1, DMRS antenna ports associated with SRS resource set with usage=codebook may be ordered first before layers associated with SRS resource set with usage=non-Codebook. When layer ordering indication is set to zero, the order of layer association may be reversed.

In general, the UE may not be expected to update the SRS precoding information for SRS resources associated with nonCodebook if the gap from the last symbol of the reception of the aperiodic NZP-CSI-RS resource and the first symbol of the aperiodic SRS transmission may be less than a predetermined number of OFDM symbols.

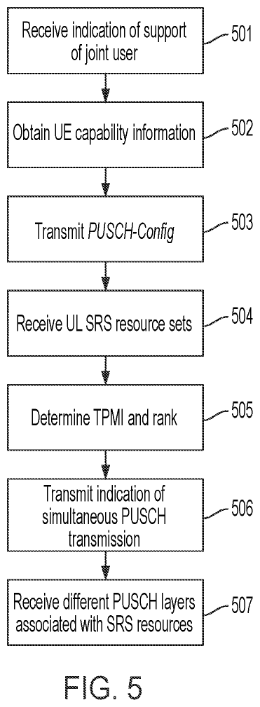

FIG. 5 illustrates an example of a flow diagram of a method for S-DCI based indications for joint usage of different precoding types for simultaneous multi-panel PUSCH that may be performed by a NE, such as NE 610 illustrated in FIG. 6, according to various example embodiments. Specifically, FIG. 5 illustrates an example for enabling simultaneous multi-panel PUSCH transmissions with multiple precoding types, wherein a UE, such as UE 620 illustrated in FIG. 6, is equipped with four TX antenna arrangements, where one pair of antenna arrangements is associated with simultaneous multi-panel PUSCH transmissions with TRP1 and TPR2.

At 501, the method may include receiving an indication, via RRC-based capability reporting for the NE, that the UE supports joint usage of different precoding types for simultaneous multi-panel PUSCH transmissions.

At 502, based on the capability signaling reporting by the UE, the method may include obtaining information about UL SRS transmission capabilities (e.g., number of antenna ports) of the UE for each reported DL resource (e.g., NZP-CSI-RS or SSB (i.e., DL TX beam direction)).

At 503, the method may include transmitting to the UE a configuration, such as is PUSCH-Config, where simultaneous multipanel PUSCH transmissions may be enabled with different precoding types (i.e., TXConfig=codebook+nonCodeBook).

At 504, based on the configured two different UL SRS resource sets, the method may include receiving simultaneously or separately in time two different UL SRS resource sets with different usages (i.e., set #1: usage=codebook and set #2: usage=non-codebook) to two different TRPs (i.e., TRP1 and TRP2).

At 505, upon reception of two different UL SRS resource sets #1 and #2 (e.g., backhaul information exchange between TRP1 and TRP2 regarding to SRS resources), the method may include determining TPMI and rank (i.e., different hypothesis on TPMI associated with rank) associated with UL SRS resource set #1 (i.e., codebook), and may determine a set of SRIs (i.e., defining precoder and rank) associated with UL SRS resource set #2 (i.e., non-codebook). Thus, upon reception of the UL SRS resource set with usage codebook, the network may need to perform different hypothesis which may include different TPMI+rank combinations (e.g., for 4 antenna port SRS), and the network may need to perform 32 different hypothesis to cover TPMIs from 0-31 also covering layers (i.e., ranks) up to 4.

At 506, the method may include indicating, via S-DCI with UL grant (e.g., DCI 0_1) that the UE may or should transmit simultaneously PUSCH via different SRS resources associated with different precoder types (i.e., codebook and non-codebook) with multiple antenna arrangements by using various DCI fields. For example, the DCI fields may include a SRS resource set indicator, wherein >0 bits may define simultaneous multipanel PUSCH transmission; otherwise, second SRI and PRI may be void, and single antenna arrangement transmissions may be assumed.

In various example embodiments, the DCI fields may also include SRS resource indicators associated with a codebook or non-codebook based PUSCH indication table, depending on the associated resource set usage (i.e., codebook or non-codebook), rather than being based solely on a single value configured in PUSCH-Config. When an associated resource set is used with the usage codebook, the codepoint field may indicate an SRI associated with the number of UL SRS resource antenna ports subject to the number of configured resources within the set, as well as subject to ul-FullPowerTransmission mode. In another example, when the associated resource set is used with usage noneCodebook, the codepoint field may indicate SRIs subject to the number of UL SRS resource resources.

In some example embodiments, the DCI fields may also include precoding information and a number of layers; this may be void if the SRS resource indicators associated with UL SRS resource set with usage equals nonCodeBook, otherwise, the DCI fields may indicate TPMI index and a number of layers (i.e., rank) subject to ul-FullPowerTransmission mode.

The DCI fields may also include a second resource indicator associated with a codebook or non-codebook based PUSCH indication table depending on the associated resource set usage (i.e., codebook or non-codebook). For example, when an associated resource set is used with a usage codebook, the codepoint field may indicate SRI associated with the number of UL SRS resource antenna ports subject to number of configured resources within the set, as well as subject to ul-FullPowerTransmission mode. Alternatively, when an associated resource set is used with noneCodebook, the codepoint field may indicate SRIs subject to the number of UL SRS resource resources.

In some example embodiments, the DCI fields may include second precoding information and a number of layers; these fields may be void if SRS resource indicator is associated UL SRS resource set with usage=nonCodeBook; otherwise, the DCI fields may indicate TPMI index and a number of layers (i.e., rank), subject to ul-FullPowerTransmission mode. It is noted that layers associated with the first and second SRI, or first and second precoding information, may not depend on each other, and may be independently indicated.

The DCI fields may also include DMRS antenna port information; for example, the codepoint field may indicate a number of DMRS CDM groups without data, as well as DMRS ports and number of frontloaded symbol. In general, first and second SRI may refer to the most recent UL SRS transmission of resource set usage (i.e., codebook and non-codebook).

At 507, upon receiving an UL S-DCI with grant, and when PUSCH-Config is configured with TXConfig=codebook+nonCodebook, the UE may implicitly assume that when two different UL SRS resource sets with difference usages (i.e., codebook and nonCodebook) are indicated, and the NE may receive different PUSCH layers (e.g., DMRS APs) associated with SRS resources with usage codebook indicated by SRI and SRS resources with usage nonCodebook indicated by SRIs.

In some example embodiments, for SRI associated with codebook based transmission, the UE may determine its codebook subsets based on TPMIs, and upon receiving higher layer parameters codebookSubset in PUSCH-Config for PUSCH associated with DCI format 0_1.

Depending on configured layer ordering for joint usage of codebook-nonCodebook, when layer ordering is set to 1, layers associated with SRS resource set with usage=codebook may be ordered firstly before layers associated with SRS resource set with usage=non-Codebook. When layer ordering for joint usage of codebook-nonCodebook indication is set to zero, the order of layer association may be reversed.

In various example embodiments, depending on configured layer ordering, when layer ordering is set to 1, DMRS antenna ports associated with SRS resource set with usage=codebook may be ordered first before layers associated with SRS resource set with usage=non-Codebook. When layer ordering indication is set to zero, the order of layer association may be reversed.

In general, the UE may not be expected to update the SRS precoding information for SRS resources associated with nonCodebook if the gap from the last symbol of the reception of the aperiodic NZP-CSI-RS resource and the first symbol of the aperiodic SRS transmission may be less than a predetermined number of OFDM symbols.

FIG. 6 illustrates an example of a system according to certain example embodiments. In one example embodiment, a system may include multiple devices, such as, for example, NE 610 and/or UE 620.

NE 610 may be one or more of a base station (e.g., 3G UMTS NodeB, 4G LTE Evolved NodeB, or 5G NR Next Generation NodeB), a serving gateway, a server, and/or any other access node or combination thereof.

NE 610 may further comprise at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5^{th} generation core (5GC).

UE 620 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 610 and/or UE 620 may be one or more of a citizens broadband radio service device (CBSD).

NE 610 and/or UE 620 may include at least one processor, respectively indicated as 611 and 621. Processors 611 and 621 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 612 and 622. The memory may be fixed or removable. The memory may include computer program instructions or computer code contained therein. Memories 612 and 622 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 611 and 621, memories 612 and 622, and any subset thereof, may be configured to provide means corresponding to the various blocks of FIGS. 3-5. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 6, transceivers 613 and 623 may be provided, and one or more devices may also include at least one antenna, respectively illustrated as 614 and 624. The device may have many antennas, such as an array of antennas configured for MIMO communications, or multiple antennas for multiple RATs. Other configurations of these devices, for example, may be provided. Transceivers 613 and 623 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 3-5). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 3-5. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

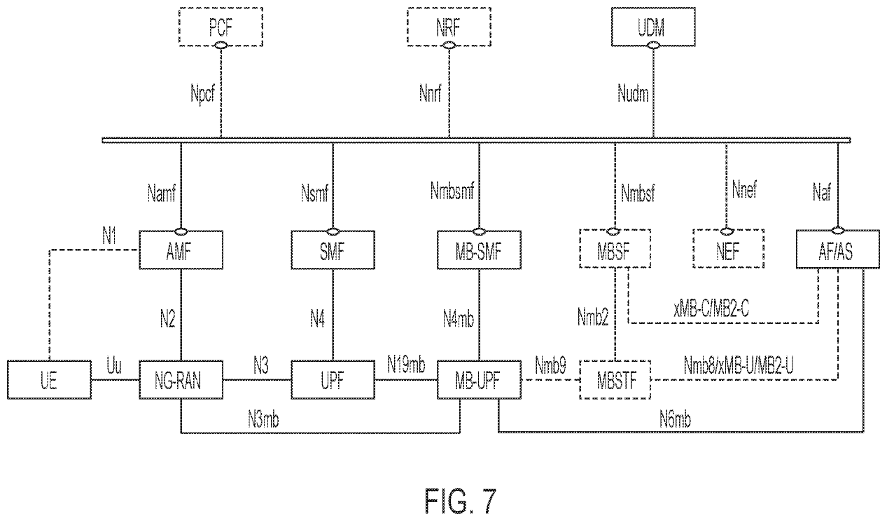

FIG. 7 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 7 may be similar to NE 610 and UE 620, respectively. The user plane function (UPF) may provide services such as intra-RAT and inter-RAT mobility, routing and forwarding of data packets, inspection of packets, user plane quality of service (QOS) processing, buffering of DL packets, and/or triggering of DL data notifications. The application function (AF) may primarily interface with the core network to facilitate application usage of traffic routing and interact with the policy framework.

According to certain example embodiments, processors 611 and 621, and memories 612 and 622, may be included in or may form a part of processing circuitry or control circuitry. In addition, in some example embodiments, transceivers 613 and 623 may be included in or may form a part of transceiving circuitry.

In some example embodiments, an apparatus (e.g., NE 610 and/or UE 620) may include means for performing a method, a process, or any of the variants discussed herein. Examples of the means may include one or more processors, memory, controllers, transmitters, receivers, and/or computer program code for causing the performance of the operations.

In various example embodiments, apparatus 620 may be controlled by memory 622 and processor 621 to receive, from a network device, uplink resource configuration information indicating that different uplink transmit precoding types are enabled for simultaneous transmissions of a plurality of uplink data channels from the apparatus; and transmit, to the network device, at least two of the plurality of uplink data channels simultaneously using the different uplink transmit precoding types.

Certain example embodiments may be directed to an apparatus that includes means for performing any of the methods described herein including, for example, means for receiving, from a network device, uplink resource configuration information indicating that different uplink transmit precoding types are enabled for simultaneous transmissions of a plurality of uplink data channels from the apparatus; and means for transmitting, to the network device, at least two of the plurality of uplink data channels simultaneously using the different uplink transmit precoding types.

In various example embodiments, apparatus 610 may be controlled by memory 612 and processor 611 to transmit, to a user equipment, uplink resource configuration information indicating that different uplink transmit precoding types are enabled for simultaneous transmissions of a plurality of uplink data channels from the user equipment; and receive, from the user equipment, at least two of the plurality of uplink data channels simultaneously using the different uplink transmit precoding types.

Certain example embodiments may be directed to an apparatus that includes means for performing any of the methods described herein including, for example, means for transmitting, to a user equipment, uplink resource configuration information indicating that different uplink transmit precoding types are enabled for simultaneous transmissions of a plurality of uplink data channels from the user equipment; and means for receiving, from the user equipment, at least two of the plurality of uplink data channels simultaneously using the different uplink transmit precoding types.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP 3^{rd} Generation Partnership Project
5G 5^{th} Generation
5GC 5^{th} Generation Core
6G 6^{th} Generation
AF Application Function
AP Antenna Point
AS Antenna Switching
ASIC Application Specific Integrated Circuit
CBSD Citizens Broadband Radio Service Device
CC Carrier Component
CDM Code Division Multiplexing
CPE Customer Premises Equipment
CPU Central Processing Unit
CSI Channel State Information
CU Centralized Unit
DCI Downlink Control Information
DL Downlink
DMRS Demodulation Reference Signal
DU Distributed Unit
eMBB Enhanced Mobile Broadband
eNB Evolved Node B
FDM Frequency Division Multiplexing
FR Frequency Range
FWA Fixed Wireless Access
gNB Next Generation Node B
GPS Global Positioning System
HDD Hard Disk Drive
IAB Integrated Access and Backhaul
IOT Internet of Things
L1 Layer 1
L2 Layer 2
LOS Line of Sight
LTE Long-Term Evolution
LTE-A Long-Term Evolution Advanced
MEMS Micro Electrical Mechanical System
MIMO Multiple Input Multiple Output
mMTC Massive Machine Type Communication
M-TRP Multi-Transmission Reception Point
NE Network Entity
NG Next Generation
NG-eNB Next Generation Evolved Node B
NG-RAN Next Generation Radio Access Network
NR New Radio
NZP Non-Zero Power
OFDM Orthogonal Frequency Division Multiplexing
PDA Personal Digital Assistance
PRI Precoding and Layer Information
PUCCH Physical Uplink Control Channel
PUSCH Physical Uplink Shared Channel
QOS Quality of Service
RAM Random Access Memory
RAN Radio Access Network
RAT Radio Access Technology
RF Radio Frequency
ROM Read-Only Memory
RRC Radio Resource Control
RS Reference Signal
S-DCI Single Downlink Control Information Indicator
SDM Spatial division multiplexing
SRI Sounding Reference Signal Resource Indicator
SRS Sounding Reference Signal
SSB Synchronization Signal Block
STx2P Simultaneous Multi-panel Uplink Transmission with 2 panels
TB Transport Block
TCI Transmission Configuration Indicator
TDM Time-Division Multiplexing
TPMI Transmitted Precoding Matrix Indicator
TRP Transmission Reception Point
TX Transmitter
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network

1. An apparatus comprising:
at least one processor; and
at least one memory storing instructions that, when executed by the at least one processor, cause the apparatus at least to:
receive, from a network device, uplink resource configuration information indicating that different uplink transmit precoding types are enabled for simultaneous transmissions of a plurality of uplink data channels from the apparatus; and
transmit, to the network device, at least two of the plurality of uplink data channels simultaneously using the different uplink transmit precoding types.

2. The apparatus of claim 1, wherein the different uplink transmit precoding types comprise codebook based transmit precoding and non-codebook based transmit precoding.

3. The apparatus of claim 1, wherein the simultaneous transmissions of the plurality of uplink data channels comprise simultaneous multi-panel transmissions for the at least two of the plurality of uplink data channels.

4. The apparatus of claim 1, wherein the at least one memory and the instructions, when executed by the at least one processor, further cause the apparatus at least to:
indicate to the network device via capability signaling, support of joint usage of the different uplink transmit precoding types for the simultaneous transmissions of the plurality of uplink data channels from the apparatus.

5. The apparatus of claim 4, wherein the capability signaling is performed via radio resource control signaling.

6. The apparatus of claim 1, wherein the uplink resource configuration information specifies associated layer ordering between the different precoding types.

7. The apparatus of claim 1, wherein the at least one memory and the instructions, when executed by the at least one processor, further cause the apparatus at least to:
transmit, via different sounding reference signal (SRS) resources, the at least two of the plurality of uplink data channels simultaneously using the different uplink transmit precoding types.

8. The apparatus of claim 7, wherein when layer ordering is set to 1, layers associated with a SRS resource set with usage of codebook based transmit precoding are ordered firstly before layers associated with a SRS resource set with usage of non-codebook based transmit precoding.

9. The apparatus of claim 7, wherein the at least one memory and the instructions, when executed by the at least one processor, further cause the apparatus at least to:
receive, from the network device, an indication that the apparatus is to transmit simultaneously the at least two of the plurality of uplink data channels via different SRS resources associated with the different uplink transmit precoding types with multiple transmit antenna arrangements.

10. The apparatus of claim 9, wherein the indication is received via single downlink control information indicator (S-DCI) or multiple downlink control information indicators (M-DCI) for a multi-transmission-reception point (M-TRP) operation for the simultaneous transmissions of the plurality of uplink data channels.

11. The apparatus of claim 10, wherein the indication reuses existing DCI codepoints for the simultaneous transmissions of the plurality of uplink data channels from the apparatus.

12. The apparatus of claim 11, wherein when the different uplink transmit precoding types are enabled, each SRS resource set usage indicates an uplink transmit precoding type indicated by a corresponding sounding reference signal resource indicator.

13. The apparatus of claim 12, wherein the at least one memory and the instructions, when executed by the at least one processor, further cause the apparatus at least to:
when two different SRS resource sets with different transmit precoding usages are indicated, transmit different uplink data channels layers associated with a SRS resource with usage of codebook based transmit precoding type and a SRS resource with usage of non-codebook based transmit precoding type as indicated by corresponding sounding reference signal resource indicators.

14. The apparatus of claim 13, wherein when layer ordering is set to 1, layers associated with a SRS resource set with usage of codebook based transmit precoding type are ordered firstly before layers associated with a SRS resource set with usage of non-codebook based transmit precoding type.

15. An apparatus comprising:
at least one processor; and
at least one memory storing instructions that, when executed by the at least one processor, cause the apparatus at least to:
transmit, to a user equipment, uplink resource configuration information indicating that different uplink transmit precoding types are enabled for simultaneous transmissions of a plurality of uplink data channels from the user equipment; and
receive, from the user equipment, at least two of the plurality of uplink data channels simultaneously using the different uplink transmit precoding types.

16. The apparatus of claim 15, wherein the different uplink transmit precoding types comprise codebook based transmit precoding and non-codebook based transmit precoding.

17. The apparatus of claim 15, wherein the simultaneous transmissions of the plurality of uplink data channels comprise simultaneous multi-panel transmissions for the at least two of the plurality of uplink data channels.

18. The apparatus of claim 15, wherein the at least one memory and the instructions, when executed by the at least one processor, further cause the apparatus at least to:
receive, from the user equipment, an indication of, via capability signaling, support of joint usage of the different uplink transmit precoding types for the simultaneous transmissions of the plurality of uplink data channels from the user equipment.

19-56. (canceled)

57. A method comprising:
receiving, by a user equipment, from a network device, uplink resource configuration information indicating that different uplink transmit precoding types are enabled for simultaneous transmissions of a plurality of uplink data channels from the user equipment; and
transmitting, to the network device, at least two of the plurality of uplink data channels simultaneously using the different uplink transmit precoding types.

58-70. (canceled)

71. A method comprising:
transmitting, to a user equipment, uplink resource configuration information indicating that different uplink transmit precoding types are enabled for simultaneous transmissions of a plurality of uplink data channels from the user equipment; and
receiving, from the user equipment, at least two of the plurality of uplink data channels simultaneously using the different uplink transmit precoding types.

72-87. (canceled)
